(19) United States
(12) Patent Application Publication
(10) Pub. No.: US 2023/0211437 A1
(43) Pub. Date: Jul. 6, 2023

(54) LASER MACHINING SYSTEM

(71) Applicant: FANUC CORPORATION, Yamanashi (JP)

(72) Inventor: Takahiro TANAKA, Yamanashi (JP)

(73) Assignee: FANUC CORPORATION, Yamanashi (JP)

(21) Appl. No.: 18/001,220

(22) PCT Filed: Jul. 9, 2021
(86) PCT No.: PCT/JP2021/026001

§ 371 Date: Dec. 8, 2022

(30) Foreign Application Priority Data
Jul. 15, 2020 (JP) 2020-121553

(51) Int. Cl. B23K 26/044; B23K 26/08

(52) U.S. Cl. CPC B23K 26/044; B23K 26/08

(57) ABSTRACT

Provided is a laser machining system that is able to carry out machining accurately even when a workpiece joint meanders. A laser machining system according to one embodiment of the present disclosure is provided with: a laser machining head having a laser optical system that has a Galvano scanner, and a tracking sensor for detecting a joint in a workpiece; a machining robot for positioning the laser machining head; a holding robot for holding the workpiece; a machining robot control unit for controlling the machining robot so as to move the laser machining head along a joint according to a design; a holding robot control unit for controlling the holding robot so as to move the workpiece such that the distance between the position of the joint as detected by the tracking sensor and the middle of the detection range of the tracking sensor remains within a prescribed range; and a Galvano scanner control unit for controlling the Galvano scanner so as to set the irradiation position of the laser light at a position that is offset by the movement amount of the workpiece from the position of the joint as detected by the tracking sensor.

### TECHNICAL FIELD

The present invention relates to a laser machining system.

### BACKGROUND ART

As laser welding, seam tracking welding has been known, in which a machining head to be moved along a designed seam of a workpiece by a robot is provided with a galvanometer scanner that sequentially adjusts a laser light irradiation position (an emission direction) by means of a reflector whose angle is adjustable and a tracking sensor that detects an actual position of the seam (a meandering seam) of the workpiece and the seam of the workpiece is accurately irradiated with laser light (see, e.g., Patent Document 1).

Patent Document 1: Japanese Unexamined Patent Application, Publication No. 2018-176164

### DISCLOSURE OF THE INVENTION

### Problems to Be Solved by the Invention

For example, sometimes in a case where two pressed steel plates are welded to each other, a seam of a workpiece meanders due to, e.g., a machining error in pressing or deformation caused by thermal stress in spot welding for temporary joint, and for this reason, an actual position of the seam greatly deviates from the position of a designed seam. In a case where the seam of the workpiece greatly meanders as described above, there is a probability of the seam deviating from a detection area of a tracking sensor. If the tracking sensor cannot detect the position of the seam, laser welding cannot be continued. For this reason, there has been a demand for a laser machining system capable of accurately performing machining even if a seam of a workpiece meanders.

### Means for Solving the Problems

The laser machining system according to one aspect of the present disclosure includes a laser machining head having a laser optical system with a galvanometer scanner that adjusts a laser light irradiation position and a tracking sensor that detects a seam of a workpiece, a machining robot that sets the position of the laser machining head, a holding robot that holds the workpiece, a machining robot control unit that controls the machining robot to move the laser machining head so as to face a designed seam and to move the laser machining head along the designed seam, a holding robot control unit that controls the holding robot to move the workpiece in a direction crossing a direction of moving the laser machining head by the machining robot such that a distance between the position of the seam detected by the tracking sensor and the center of a detection area of the tracking sensor is within a predetermined area, and a galvanometer scanner control unit that controls the galvanometer scanner to set the laser light irradiation position at a position offset from the position of the seam detected by the tracking sensor by the amount of movement of the workpiece by the holding robot.

### Effects of the Invention

According to the laser machining system of the present disclosure, machining can be accurately performed even if the seam of the workpiece meanders.

### BRIEF DESCRIPTION OF THE DRAWINGS

FIG. 1 is a schematic view showing the configuration of a laser machining system according to one embodiment of the present disclosure; and

FIG. 2 is a flowchart showing steps of control in the laser machining system of FIG. 1.

### PREFERRED MODE FOR CARRYING OUT THE INVENTION

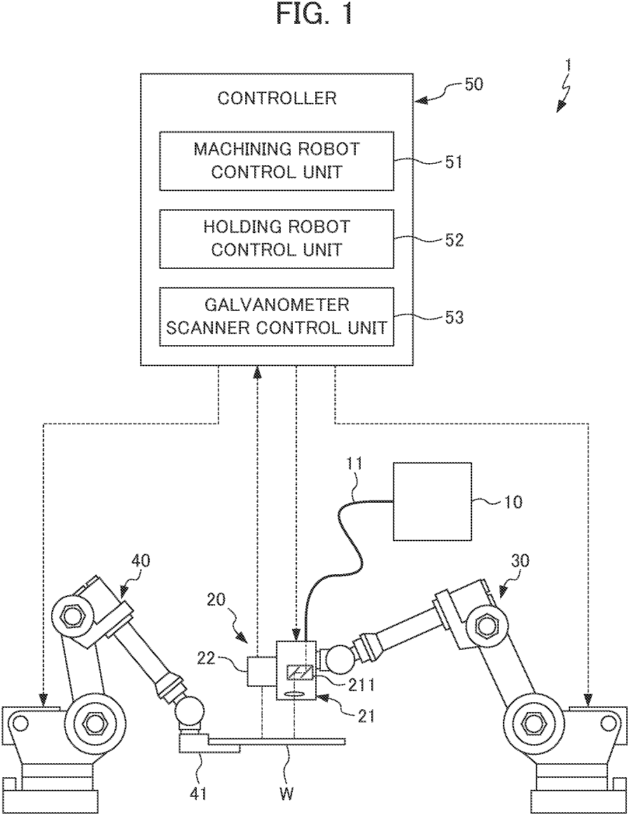

Hereinafter, an embodiment of a laser machining system according to the present disclosure will be described with reference to the drawings. FIG. 1 is a schematic view showing the configuration of a laser machining system 1 according to one embodiment of the present disclosure.

The laser machining system 1 irradiates a workpiece W with laser light along a seam of the workpiece W to weld the workpiece W. The laser machining system 1 includes a laser oscillator 10, a laser machining head 20, a machining robot 30 that sets the position of the laser machining head 20, a holding robot 40 that holds the workpiece W, and a controller 50 that controls the laser machining head 20, the machining robot 30, and the holding robot 40.

For example, a fiber laser, a carbon dioxide gas laser, or a YAG laser may be used as the laser oscillator 10. The laser oscillator 10 may be mounted on the laser machining head 20, but may be arranged independently of the machining robot 30 and may supply laser light to the laser machining head 20 through, e.g., an optical fiber 11.

The laser machining head 20 has a laser optical system 21 and a tracking sensor 22. The laser optical system 21 and the tracking sensor 22 are arranged so as not to move relative to each other.

The laser optical system 21 has a galvanometer scanner 211 that adjusts a laser light emission direction by means of movable reflectors. Thus, the laser optical system 21 can irradiate an optional position in a certain area with laser light.

The galvanometer scanner 211 includes, on a laser light path, two reflectors rotatable about rotation axes perpendicular to each other, and these reflectors are rotatably driven by a servomotor to adjust the laser light emission direction.

For example, a sensor that measures a distance by scanning with laser light in one direction is used as the tracking sensor 22. Such a tracking sensor 22 detects, as the workpiece seam, a point whose distance to the workpiece W changes discontinuously. The tracking sensor 22 is preferably arranged to measure the distance by scanning in a direction perpendicular to a direction of moving the laser machining head 20 by the later-described machining robot 30.

The machining robot 30 holds the laser machining head 20 at an end portion whose spatial position and orientation are changeable. With this configuration, the machining robot 30 can move the laser machining head 20 along a desired trajectory. The machining robot 30 is not particularly limited, and, e.g., a vertical articulated robot, a SCARA robot, a parallel link robot, or an orthogonal coordinate robot may be used as the machining robot 30. Alternatively, the machining robot 30 may be a simple robot that axially feeds in one direction or two directions by, e.g., a linear motor, such as a positioner or an actuator.

The holding robot 40 is provided with, e.g., a holding head 41 that holds the workpiece W at a positionable end portion. The holding robot 40 is not particularly limited, and, e.g., a vertical articulated robot, a SCARA robot, a parallel link robot, or an orthogonal coordinate robot may be used as the holding robot 40. Alternatively, the holding robot 40 may be a simple robot that axially feeds a table holding the workpiece W in one direction or two directions by, e.g., a ball screw or a linear motor, such as a positioner or an actuator.

The controller 50 includes a machining robot control unit 51 that controls the machining robot 30, a holding robot control unit 52 that controls the holding robot 40, and a galvanometer scanner control unit 53 that controls the galvanometer scanner 211.

The controller 50 can be implemented in such a manner that a proper control program is installed in a computer device having a CPU, a memory, etc. Each component of the controller 50 may be implemented by an independent piece of hardware, or the components of the controller 50 may be implemented by a single piece of hardware. That is, each component of the controller 50 is the type of function of the controller 50, and is not necessarily clearly distinguishable in a mechanical structure and a program structure of the controller 50. The controller 50 may further have components that implement other functions.

The machining robot control unit 51 controls the machining robot 30 to move the display device 20 so as to face a designed seam of the workpiece W and to move the display device 20 along the designed seam. That is, the machining robot control unit 51 moves, typically linearly moves, the laser machining head 20 along a single seam at a certain speed. Such operation of the machining robot 30 by the machining robot control unit 51 is specified in advance by, e.g., a program created based on a designed shape of the workpiece W or a teaching operation of an operator instructing the posture of the machining robot 30 such that the laser machining head 20 faces the workpiece W.

The holding robot control unit 52 controls the holding robot 40 to move the workpiece W in a direction crossing the direction of moving the laser machining head 20 by the machining robot 30 such that a distance between the position of the seam detected by the tracking sensor 22 and the center of a detection area (a scanning area) of the tracking sensor 22 is within a predetermined area. The direction of moving the workpiece W by the holding robot 40 is, in order to reduce a computational burden, preferably a direction perpendicular to the direction of moving the laser machining head 20 and perpendicular to the center axis (an optical axis direction of laser light emitted in a standard state) of the laser machining head 20.

The holding robot control unit 52 may be configured to control the holding robot 40 to move the workpiece W such that the position of the seam detected by the tracking sensor 22 moves to the center side of the detection area of the tracking sensor 22. That is, the holding robot control unit 52 may be configured to take, as input, the amount of shift of the position of the seam detected by the tracking sensor 22 from the center of the detection area of the tracking sensor 22, thereby setting the amount of movement of the workpiece W by the holding robot 40 such that such a shift amount decreases.

As one example, the holding robot control unit 52 may correct a command value for the holding robot 40 in real time, thereby controlling the holding robot 40 such that the position of the seam detected by the tracking sensor 22 is substantially constantly coincident with the center of the detection area of the tracking sensor 22.

However, there is a probability that there is a delay in detection by the tracking sensor 22 or upper limits are set for the speed, acceleration, jerk, etc. of the holding robot 40 in order to prevent overload, vibration, etc. For this reason, the holding robot control unit 52 may determine the movement speed of the workpiece W by, e.g., PID control taking, as an input value, the amount of shift of the position of the seam detected by the tracking sensor 22 from the center of the detection area of the tracking sensor 22.

As another alternative, the holding robot control unit 52 may control the holding robot 40 to move the workpiece W at the maximum speed with a predetermined profile only in a case where the distance between the position of the seam detected by the tracking sensor 22 and the center of the detection area of the tracking sensor 22 exceeds an upper limit. In a case where the amount of shift of the seam detected by the tracking sensor 22 from the center of the detection area in a positive direction has reached a predetermined upper limit, the holding robot control unit 52 may start an operation of controlling the holding robot 40 to move the workpiece W in the positive direction. In a case where the amount of shift of the seam detected by the tracking sensor 22 from the center of the detection area in a negative direction has reached a predetermined upper limit, the holding robot control unit 52 may start an operation of controlling the holding robot 40 to move the workpiece W in the negative direction.

In some cases, the seam of the workpiece W cannot be constantly arranged at the center of the detection area of the tracking sensor 22 only by control of the holding robot 40 by the holding robot control unit 52 as described above. However, the holding robot control unit 52 controls the holding robot 40 to move the workpiece W so that shift of the seam of the workpiece W from the center of the detection area of the tracking sensor 22 can be reduced. Accordingly, a probability of a target laser light irradiation position being unable to be identified due to deviation of the seam of the workpiece W from the detection area of the tracking sensor 22 can be eliminated.

The galvanometer scanner control unit 53 controls the galvanometer scanner 211 to set the laser light irradiation position at a position offset from the position of the seam detected by the tracking sensor 22 by the amount of movement of the workpiece W by the holding robot 40. That is, the galvanometer scanner control unit 53 calculates a shift amount between the position of the workpiece W at a moment at which the position of the seam is detected by the tracking sensor 22 and the position of the workpiece W at a moment at which such a workpiece position is irradiated with laser light by the laser optical system 21, thereby correcting the laser light irradiation position, which is to be input to the galvanometer scanner 211, in a coordinate system of the laser machining head 20.

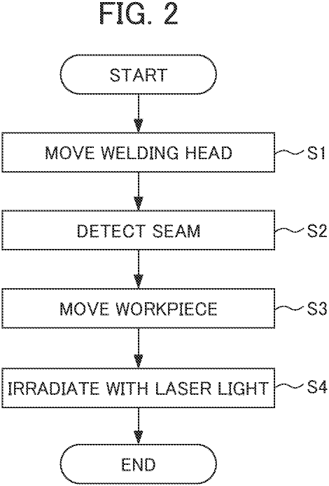

FIG. 2 shows steps of controlling laser welding by the laser machining system 1, i.e., steps of control by the controller 50. Laser welding by the laser machining system 1 is performed by a method including a step (Step S1: a machining head movement step) of moving the laser machining head 20, a step (Step S2: a seam detection step) of detecting an actual position of the seam of the workpiece W, a step (Step S3: a workpiece movement step) of moving the workpiece W, and a step (Step S4: a laser light irradiation step) of irradiating the workpiece W with laser light.

In the machining head movement step of Step S1, the laser machining head 20 is moved by the machining robot 30. That is, the machining robot control unit 51 operates the machining robot 30 according to the machining program or the teaching data, thereby linearly moving the laser machining head 20 (the laser optical system 21 and the tracking sensor 22) along the seam of the workpiece W at the certain speed.

In the seam detection step of Step S2, the position of the seam of the workpiece W is detected by the tracking sensor 22. Specifically, the controller 50 acquires the position of the seam of the workpiece W in a coordinate system of the tracking sensor 22 from the tracking sensor 22, thereby calculating the position of the seam of the workpiece W in a task coordinate system of the laser machining system 1 from the position and orientation of the tracking sensor 22 in the task coordinate system.

In the workpiece movement step of Step S3, the holding robot control unit 52 controls the holding robot 40 to move the workpiece W such that the seam of the workpiece W approaches the center of the detection area of the tracking sensor 22 in the direction perpendicular to the movement direction of the laser machining head 20.

In the laser light irradiation step of Step S4, the seam of the workpiece W is irradiated with laser light by the laser optical system 21. That is, the galvanometer scanner control unit 53 controls the galvanometer scanner 211 to set the laser light irradiation position at the position offset from the position of the seam of the workpiece W detected by the tracking sensor 22 by the amount (the distance and the direction) equal to the amount of movement of the workpiece W by the holding robot 40.

Note that FIG. 2 simply shows the flow of the process for the same task coordinate system in control by the controller 50, and a single process in each step does not correspond to a single process in another step. Before completion of a process in a certain step in FIG. 2, a process in a next cycle of a previous step may be performed. That is, a cycle of the machining robot control unit 51 providing a command to the machining robot 30, a cycle of the tracking sensor 22 detecting the position of the seam of the workpiece W, a cycle of the holding robot control unit 52 providing a command to the holding robot 40, and a cycle of the galvanometer scanner control unit 53 instructing the laser light irradiation position to the galvanometer scanner 211 may be different from each other.

As described above, in the laser machining system 1, the holding robot 40 moves the workpiece W such that meandering along the seam of the workpiece W is reduced, and therefore, deviation of the seam of the workpiece W from the detection area of the tracking sensor 22 can be prevented. Thus, even in a case where the seam of the workpiece W greatly meanders, the seam of the workpiece W can be reliably irradiated with laser light, and the workpiece W can be accurately welded.

Preferably, in order to easily perform a machining technique of irradiating the workpiece W with laser light along the seam of the workpiece W by means of the tracking sensor 22 and welding the workpiece W, the laser machining head 20 performs laser machining so as to follow the meandering workpiece seam, the machining robot 30 holding the laser machining head 20 is taught only about simple linear operation, and such taught operation is not changed. In a case where there is a plurality of machining spots in addition to a spot at which the workpiece W is welded along the seam thereof, if the operation taught to the machining robot 30 is changed, such an operation change is not preferable because it is necessary to re-adjust the position and timing of laser irradiation by the laser machining head 20. According to the laser machining system 1 of the present disclosure, even if the seam of the workpiece W greatly meanders, welding can be accurately performed without the need for changing the simple operation taught to the machining robot 30 holding the laser machining head 20.

The embodiment of the laser machining system according to the present disclosure has been described above, but the scope of the present disclosure is not limited to the above-described embodiment. The advantageous effects described above in the embodiment are merely listed as most suitable advantageous effects of the laser machining system according to the present disclosure, and the advantageous effects of the laser machining system according to the present disclosure are not limited to those described above in the embodiment. Specifically, the laser machining system according to the present disclosure may be a system that performs machining such as cutting by laser irradiation.

### EXPLANATION OF REFERENCE NUMERALS

1 Laser Machining System
10 Laser Oscillator
11 Optical Fiber
20 Laser Machining Head
21 Laser Optical System
211 Galvanometer Scanner
22 Tracking Sensor
30 Machining Robot
40 Holding Robot
41 Holding Head
50 Controller
51 Machining Robot Control Unit
52 Holding Robot Control Unit
53 Galvanometer Scanner Control Unit
W Workpiece

1. A laser machining system comprising:
a laser machining head having a laser optical system with a galvanometer scanner that adjusts a laser light irradiation position and a tracking sensor that detects a seam of a workpiece;
a machining robot that sets a position of the laser machining head;
a holding robot that holds the workpiece;
a machining robot control unit that controls the machining robot to move the laser machining head so as to face a designed seam and to move the laser machining head along the designed seam;
a holding robot control unit that controls the holding robot to move the workpiece in a direction crossing a direction of moving the laser machining head by the machining robot such that a distance between a position of the seam detected by the tracking sensor and a center of a detection area of the tracking sensor is within a predetermined area; and
a galvanometer scanner control unit that controls the galvanometer scanner to set the laser light irradiation position at a position offset from the position of the seam detected by the tracking sensor by an amount of movement of the workpiece by the holding robot.

2. The laser machining system according to claim 1, wherein the holding robot control unit controls the holding robot to move the workpiece such that the position of the seam detected by the tracking sensor moves to a center side of the detection area of the tracking sensor.

3. The laser machining system according to claim 1, wherein the machining robot is a vertical articulated robot.
